(19) United States
(12) Patent Application Publication
(10) Pub. No.: US 2026/0104585 A1
(43) Pub. Date: Apr. 16, 2026

(54) OPTICAL SCANNER

(71) Applicant: Hand Held Products, Inc., Charlotte, NC (US)

(72) Inventors: Zhiying LIU, Charlotte, NC (US); Jie CHENG, Charlotte, NC (US); Chenhui YU, Charlotte, NC (US); Jun YIN, Charlotte, NC (US); Feng GU, Charlotte, NC (US)

(21) Appl. No.: 19/339,790

(22) Filed: Sep. 25, 2025

(30) Foreign Application Priority Data
Oct. 10, 2024 (CN) 202411411619.1

(51) Int. Cl. G02B 27/00; G02B 5/30; G02B 27/30

(52) U.S. Cl. CPC G02B 27/0018; G02B 5/3025; G02B 5/3083; G02B 27/30

(57) ABSTRACT

An optical scanner comprising an aimer light source to emit highly polarized light, a window, and a linear polarizer positioned between the aimer light source and the window. Further, the linear polarizer receives the highly polarized light and converts into linear polarized light. Further, a quarter-wave plate is positioned between the linear polarizer and the window. Further, the quarter-wave plate receives the linear polarized light and converts into circularly polarized light. Therefore, the linear polarizer and the quarter-wave plate prevent back reflection of the circularly polarized light from the window from reaching the aimer light source for preventing an aimer ghost light.

### CROSS-REFERENCE TO RELATED APPLICATION

This application claims priority pursuant to 35 U.S.C. 119(a) to Chinese Application No. 202411411619.1 filed Oct. 10, 2024, which application is incorporated herein by reference in its entirety.

### TECHNOLOGICAL FIELD

Example embodiments of the present disclosure relate generally to an optical scanner, and more particularly to an optical scanner and a method thereof for preventing reflections.

### BACKGROUND

Barcode scanners capture and decode information from barcodes, typically using laser or imaging technology. Imaging-based barcode scanners, among the most common types, operate by projecting a laser beam onto the barcode. These scanners consist of an imaging system, an illumination system, an aimer projector, and a microcontroller unit (MCU). The aimer projector which uses a visible laser diode (VLD) as its light source, projects a visible light spot that aids in locating the barcode within the image and enhances the scanner's decoding capabilities. A lens is positioned near the VLD to collimate the emitted light and convert the divergent light into a parallel light beam. The parallel light beam then passes through a protective window before striking a target laser die. However, the VLD has a highly reflective surface, except for a small emitting area. When light reflected from the protective window strikes the reflective surface of the die, it is reflected again, passing back through the collimator lens and the protective window. This reflection creates a darker “ghost” of the aimer on the target, resulting in an unintended secondary projection near the intended laser spot. This ghost image can interfere with the scanner's accuracy, potentially leading to confusion, errors, and operational inefficiencies of the scanner.

The inventors identified numerous deficiencies and problems in existing technologies and processes, which are the subjects of embodiments described herein. Through applied effort, ingenuity, and innovation, many of these deficiencies and problems have been solved by developing solutions that are included in embodiments of the present disclosure, many examples of which are described in detail herein.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, an optical scanner is disclosed. The optical scanner comprising an aimer light source to emit highly polarized light, a window, a linear polarizer positioned between the aimer light source and the window. Further, the linear polarizer is configured to receive the highly polarized light and converts into linear polarized light, a quarter-wave plate positioned between the linear polarizer and the window. Further, the quarter-wave plate receives the linear polarized light and converts it into circularly polarized light, Further, the linear polarizer and the quarter-wave plate prevent back reflection of the circularly polarized light from the window reaching the aimer light source, for preventing an aimer ghost light.

In some embodiments, the aimer light source corresponds to at least a visible laser diode (VLD) light source.

In some embodiments, a collimator lens positioned between the aimer light source and the linear polarizer. In some embodiments, the collimator lens collimates the highly polarized light into a beam of parallel light that is received by the linear polarizer.

In some embodiments, the highly polarized light is converted into the linear polarized light with parallel direction, by the linear polarizer.

In some embodiments, the circularly polarized light converted from the linear polarized light by the quarter-wave plate corresponds to left-handed circularly polarized light or right-handed circularly polarized light. In some embodiments, the window reflects the left-handed circularly polarized light into the right-handed circularly polarized light or the right-handed circularly polarized light into the left-handed circularly polarized light. In some embodiments, the quarter-wave plate is configured to convert the left-handed circularly polarized light or the right-handed circularly polarized light received from the window into vertically polarized light.

In some embodiments, the direction of the vertically polarized light is perpendicular to an axis of the linear polarizer such that the linear polarizer prevents the vertically polarized light from reflecting back to the aimer light source and thereby preventing the aimer ghost light. In some embodiments, the axis of the linear polarizer is positioned in a predefined degree to transmit the linear polarized light at a maximum intensity.

In some embodiments, the quarter-wave plate comprises a first axis and a second axis. Further, the quarter-wave plate is positioned relative to the linear polarizer such that the first axis and the second axis of the quarter-wave plate each form a 45-degrees angle with the axis of the linear polarizer.

In some embodiments, the aimer light source, the collimator lens, the linear polarizer, the quarter-wave plate, and the window are positioned in the same plane and collectively generate an aimer light.

In another example embodiment, a method is disclosed. The method comprising emitting, via an aimer light source of an optical scanner, highly polarized light; converting, via a linear polarizer positioned between the aimer light source and a window, the highly polarized light received from the aimer light source into linear polarized light; and converting, via a quarter-wave plate positioned between the linear polarizer and the window, the linear polarized light received from the linear polarizer into circularly polarized light. Further, the linear polarizer and the quarter-wave plate prevent back reflection of the circularly polarized light from the window from reaching the aimer light source, for preventing an aimer ghost light.

The above summary is provided merely for purposes of summarizing some exemplary embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and accompanying drawings.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an architectural view of an optical scanner in accordance with an example embodiment of the present disclosure;

FIGS. 2A-2B illustrate working of the optical scanner in accordance with an example embodiment of the present disclosure;

FIG. 3A illustrates a linear polarized light in accordance with an example embodiment of the present disclosure; and,

FIG. 3B illustrates a circularly polarized light in accordance with an example embodiment of the present disclosure.

### DETAILED DESCRIPTION OF THE INVENTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The present disclosure provides various embodiments of an optical scanner. Embodiments of the present disclosure may comprise an aimer light source that emits highly polarized light. Embodiments of the present disclosure may comprise a window. Embodiments of the present disclosure may comprise a linear polarizer that is positioned between the aimer light source and the window. The linear polarizer may receive the highly polarized light and convert into linear polarized light. Embodiments of the present disclosure may comprise a quarter-wave plate that is positioned between the linear polarizer and the window. The quarter-wave plate may receive the linear polarized light and convert the linear polarized light into circularly polarized light. The linear polarizer and the quarter-wave plate may prevent back reflection of the circularly polarized light from the window from reaching the aimer light source, for preventing an aimer ghost light.

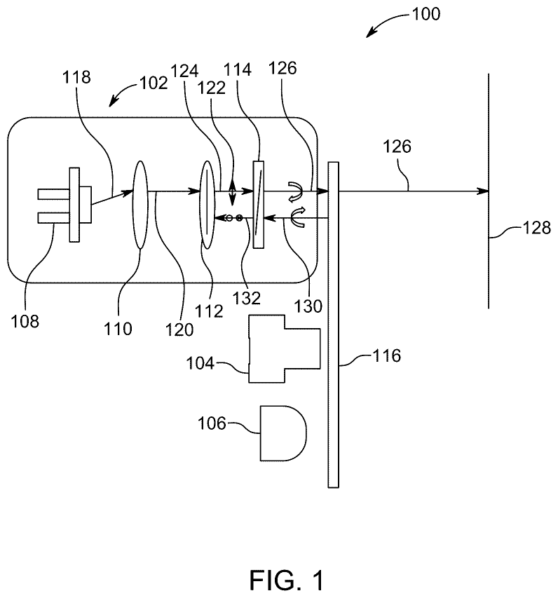

FIG. 1 illustrates an architectural view of an optical scanner 100, in accordance with an example embodiment of the present disclosure.

In some embodiments, the optical scanner 100 may comprise an aimer 102, an imaging system 104, and an illumination system 106. In some embodiments, the optical scanner 100 may be configured to scan one or more visual codes (not shown) from at least one object (not shown). The one or more visual codes may comprise at least one barcode, quick response (QR) code, etc. In some embodiments, at least one object may comprise at least one of cartons, packages, etc. In various examples, the optical scanner 100 may be installed on an external system (not shown) such as conveyors, logistic systems, etc. In various other examples, the optical scanner 100 may be integrated within a hand-held unit (not shown), door (not shown) etc. In some embodiments, the optical scanner 100 may be configured to scan one or more visual codes and interpret information encoded within one or more visual codes. In some embodiments, the information may include, but is not limited to, details about a type of object being scanned, category or model of the at least one object, manufactured of at least one object, and/or supplier of at least one object. In some embodiments, the optical scanner 100 may comprise a window 116 positioned in front of the aimer 102, the imaging system 104, and the illumination system 106.

In various examples, the optical scanner 100 may comprise a housing (not shown). In some embodiments, the housing of the optical scanner 100 may be configured to protect one or more components (i.e., the aimer 102, the imaging system 104, and the illumination system 106) of the optical scanner 100 from various conditions. The conditions may include, but are not limited to, extreme temperatures or high-pressure environments. In some embodiments, the housing of the optical scanner 100 may be constructed with various materials. The materials may include, but are not limited to, a metal, plastic, or polycarbonate. The materials of the housing may be selected such that the housing of the optical scanner 100 may withstand the various conditions.

In some embodiments, the optical scanner 100 may comprise the aimer 102. In some embodiments, the aimer 102 of the optical scanner 100 may facilitate positioning of the optical scanner 100 such that a field of view (FOV) of the optical scanner 100 covers at least one object. In some embodiments, the aimer 102 of the optical scanner 100 may be configured to project a pattern of lights towards the at least one object. Further, the pattern of lights may include, but is not limited to, a dot, line, or crosshair. In some embodiments, the pattern of lights projected by the aimer 102 may facilitate aligning of the optical scanner 100 with at least one object. Further, the alignment of the optical scanner 100 with the at least object may ensure a proper scanning of the one or more visual codes of the at least one object. For example, an aimer 102 of a barcode scanner is configured to project a pattern of lights towards a barcode that may be imprinted on a package. The barcode scanner is positioned at a distance from the package such that the pattern of lights completely aligns with the barcode.

In some embodiments, the aimer 102 of the optical scanner 100 may comprise an aimer light source 108, a collimator lens 110, a linear polarizer 112, and a quarter-wave plate 114. In some embodiments, the aimer light source 108 may be integrated within the aimer 102 of the optical scanner 100. In some embodiments, the aimer light source 108 may be configured to emit a highly polarized light 118 towards the FOV of the aimer 102. In some embodiments, the aimer light source 108 may correspond to at least a visible laser diode (VLD) light source. In some embodiments, the aimer light source 108 of the aimer 102 may be configured to emit a narrow coherent beam of visible light (i.e., the highly polarized light 118). In some embodiments, the highly polarized light 118 emitted by the aimer light source 108 may facilitate aligning of the optical scanner 100 with a target area (i.e., the one or more visual codes on the at least one object). In various examples, the aimer light source 108 of the aimer 102 may be coupled with a power source (not shown). Further, the power source may be configured to supply electric power to the aimer light source 108 for emitting the highly polarized light 118 towards at least one object. In some embodiments, the highly polarized light 118 corresponds to light waves in which the magnetic fields oscillate predominantly in a single direction (i.e., one linear polarization) or plane.

In some embodiments, the aimer 102 may further comprise the collimator lens 110. In some embodiments, the collimator lens 110 may be positioned between the aimer light source 108 and the linear polarizer 112. In some embodiments, the collimator lens 110 may be positioned at an equal distance from the aimer light source 108 and the linear polarizer 112. In some embodiments, the collimator lens 110 of the optical scanner 100 may be configured to collimate the highly polarized light 118 into a beam of parallel light 120 that may be received by the linear polarizer 112. In some embodiments, the collimator lens 110 of the optical scanner 100 may be configured to perform a collimation process. The collimation process may involve converting of light rays of the highly polarized light 118 from a diverging (e.g., spreading out) state into a parallel or nearly parallel state with respect to the FOV of the optical scanner 100. In some embodiments, the highly polarized light 118 emitted by the aimer light source 108 may be configured to diverge. Further, the collimator lens 110 of the optical scanner 100 may be configured to capture the highly polarized light 118 and redirect the captured highly polarized light 118 into the beam of parallel light 120.

In some embodiments, the collimator lens 110 of the optical scanner 100 may be composed of various materials. The materials may include, but are not limited to, glass, plastic (i.e., polymer), crystal (e.g., sapphire, quartz, etc.), aspheric materials, Fresnel lenses, etc. In some embodiments, the materials of the collimator lens 110 may be selected such that the collimator lens 110 may have precise optical properties, durability, and suitability. In some embodiments, the beam of parallel light 120 collimated by the collimator lens 110 may travel into multiple axes (e.g., vertical axis, horizontal axis, longitudinal axis, etc.). In some embodiments, upon collimation of the beam of parallel light 120 (i.e., the highly polarized light 118) by the collimator lens 110, the beam of parallel light 120 may be configured to travel towards the linear polarizer 112.

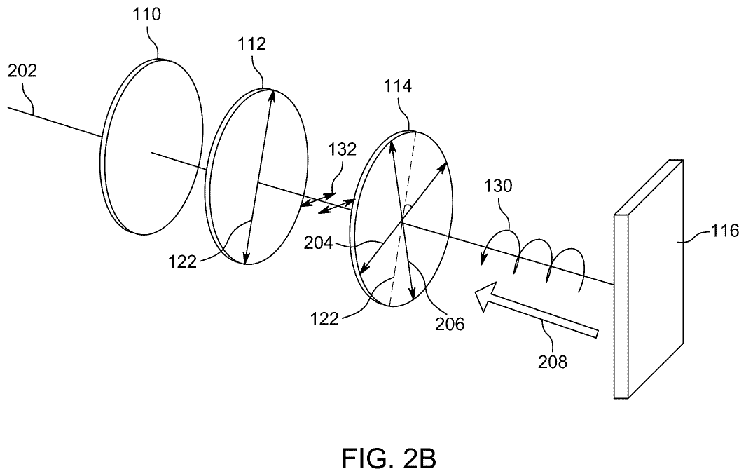

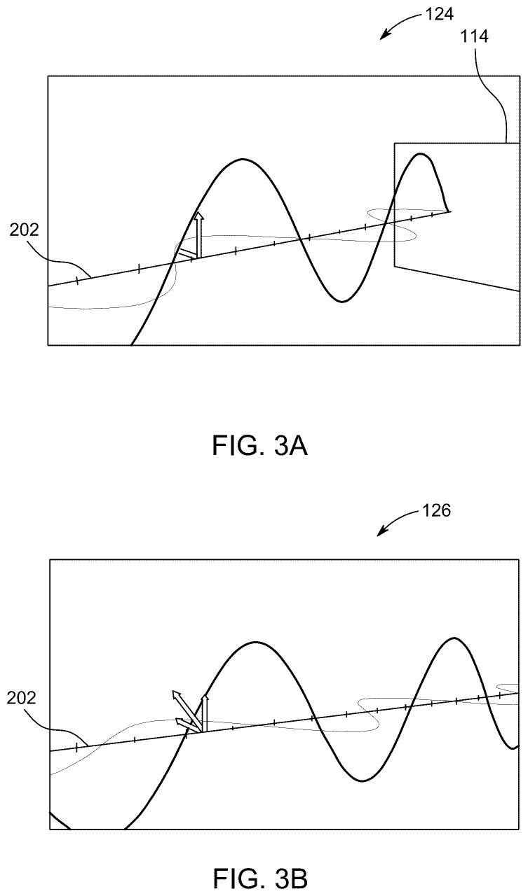

In some embodiments, the linear polarizer 112 of the optical scanner 100 may be positioned between the aimer light source 108 and the window 116. In some embodiments, the linear polarizer 112 of the optical scanner 100 may be configured to receive the highly polarized light 118. In some embodiments, the linear polarizer 112 of the optical scanner 100 may be configured to convert the highly polarized light 118 into a linear polarized light 124 (illustrated in FIG. 3A). In various embodiments, the linear polarizer 112 may be equidistantly placed between the collimator lens 110 and the quarter-wave plate 114. In some embodiments, the linear polarizer 112 of the optical scanner 100 may be configured to control and refine polarization of the highly polarized light 118. In some embodiments, the linear polarizer 112 may be configured to receive the highly polarized light 118 that may be collimated into the beam of parallel light 120 by the collimator lens 110. In some embodiments, the highly polarized light 118 entering into the linear polarizer 112 may have light rays travelling into multiple axes.

In some embodiments, the linear polarizer 112 of the optical scanner 100 may define a vertical polarization axis 122. In some embodiments, the linear polarizer 112 may be configured to filter the light rays of the highly polarized light 118 having an axis perpendicular to the vertical polarization axis 122 of the linear polarizer 112. In some embodiments, the linear polarizer 112 may be configured to enable passage of the light of the highly polarized light 118 having an axis parallel to the vertical polarization axis 122 of the linear polarizer 112. In some embodiments, the highly polarized light 118 may be converted into the linear polarized light 124 with parallel direction by the linear polarizer 112. In some embodiments, the linear polarizer 112 of the optical scanner 100 may be configured to provide the linear polarized light 124. In some embodiments, the linear polarizer 112 of the optical scanner 100 may be composed of various materials. The material of the linear polarizer 112 may include, but are not limited to, polarizing film, calcite crystals, quartz crystal, etc. The material of the linear polarizer 112 may be selected such that the linear polarizer 112 of the optical scanner 100 may have a high degree of efficiency and quality of polarization.

In some embodiments, the optical scanner 100 may comprise the quarter-wave plate 114. In some embodiments, the quarter-wave plate 114 of the optical scanner 100 may be positioned between the linear polarizer 112 and the window 116. In some embodiments, the quarter-wave plate 114 of the optical scanner 100 may be configured to receive the linear polarized light 124 from the linear polarizer 112 of the optical scanner 100. In some embodiments, the quarter-wave plate 114 of the optical scanner 100 may be configured to convert the received linear polarized light 124 into circularly polarized light 126 illustrated in FIG. 3B). In some embodiments, the quarter-wave plate 114 may be configured to introduce a phase difference of 90 degrees (i.e., a quarter wavelength) into the linear polarized light 124 received from the linear polarizer 112. Further, the phase shift (i.e., 90 degrees) of the linear polarized light 124 may cause the linear polarized light 124 to convert into the circularly polarized light 126. In some embodiments, the circularly polarized light 126 that may be converted from the linear polarized light 124 by the quarter-wave plate 114 may correspond to left-handed circularly polarized light or right-handed circularly polarized light.

In some embodiments, the optical scanner 100 may comprise the window 116. In some embodiments, the circularly polarized light 126 passing through the quarter-wave plate 114, may be configured to travel towards the window 116. In some embodiments, the window 116 of the optical scanner 100 may be configured to receive the circularly polarized light 126. In some embodiments, the window 116 of the optical scanner 100 may be configured to allow passage to the circularly polarized light 126. In some embodiments, the circularly polarized light 126 passed through the window 116 may be configured to strike over a target plane 128 of at least one object. In some embodiments, the optical scanner 100 may be configured to scan the one or more visual codes imprinted on the target plane 128 of the at least on object through the circularly polarized light 126 passed through the window 116.

In some embodiments, the window 116 of the optical scanner 100 may be configured to reflect a portion of the circularly polarized light 130 back towards the quarter-wave plate 114. In some embodiments, the window 116 may be configured to reflect the left-handed circularly polarized light into the right-handed circularly polarized light or the right-handed circularly polarized light into the left-handed circularly polarized light. In some embodiments, the quarter-wave plate 114 of the optical scanner 100 may be configured to receive the portion of the circularly polarized light 130 that may be reflected by the window 116. In some embodiments, the quarter-wave plate 114 may be configured to convert the left-handed circularly polarized light or the right-handed circularly polarized light received from the window 116 into vertically polarized light 132. In some embodiments, the vertically polarized light 132 may define a direction. In some embodiments, the direction of the vertically polarized light 132 may be perpendicular to an axis (i.e., the vertical polarization axis 122) of the linear polarizer 112. In some embodiments, the linear polarizer 112 of the optical scanner 100 may be configured to receive the vertically polarized light 132. In some embodiments, the linear polarizer 112 of the optical scanner 100 may be configured to prevent the vertically polarized light 132 from reflecting back to the aimer light source 108, thereby preventing an aimer ghost light. In some embodiments, the linear polarizer 112 and the quarter-wave plate 114 may be configured to prevent back reflection of the circularly polarized light 126 from the window 116 from reaching the aimer light source 108 for preventing the aimer ghost light.

In some embodiments, the imaging system 104 of the optical scanner 100 may be configured to capture one or more images of the one or more visual codes of at least one object. In some embodiments, the imaging system 104 may comprise one or more sensors and processors (not illustrated) that may be configured to extract required information from the one or more images of the one or more visual codes of at least one object. In some embodiments, the illumination system 106 of the optical scanner 100 may be configured to provide ambient light to surroundings of the at least one object to enable proper scanning of the one or more visual codes of the at least one object. In some embodiments, the illumination system 106 may comprise at least one of a light emitting diode (LED) panel, a light bulb, a florescent lamp, etc.

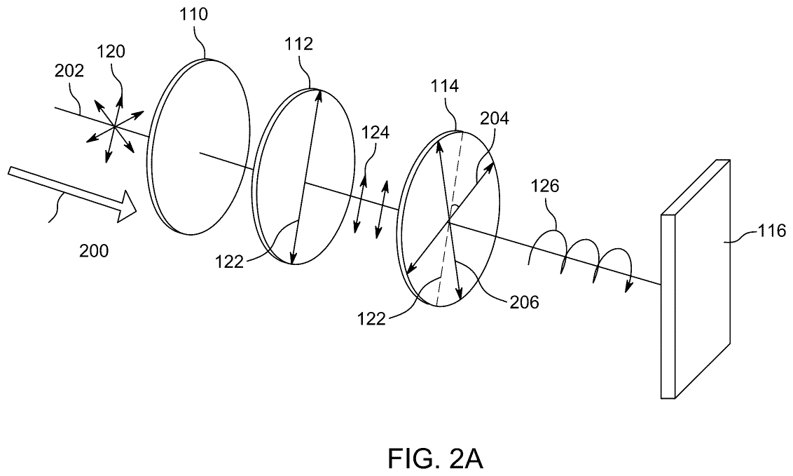

FIGS. 2A-2B illustrate working of the optical scanner 100, in accordance with an example embodiment of the present disclosure. FIG. 3A illustrates the linear polarized light 124, in accordance with an example embodiment of the present disclosure. FIG. 3B illustrates the circularly polarized light 126, in accordance with an example embodiment of the present disclosure.

In some embodiments, the aimer light source 108 of the optical scanner 100 may be configured to emit the highly polarized light 118. In some embodiments, the highly polarized light 118 emitted by the aimer light source 108 may be configured to travel towards the FOV of the optical scanner 100, as depicted by an arrow 200 in FIG. 2A. In some embodiments, the aimer light source 108, the collimator lens 110, the linear polarizer 112, the quarter-wave plate 114, and the window 116 may be positioned in a same plane 202 and collectively generate an aimer light. In some embodiments, the collimator lens 110 of the optical scanner 100 may be configured to receive the highly polarized light 118. Further, the collimator lens 110 of the optical scanner 100 may be configured to collimate the highly polarized light 118 into the beam of parallel light 120. In some embodiments, the beam of parallel light 120 may have multiple axes. In some embodiments, the beam of parallel light 120 may be configured to travel towards the linear polarizer 112 of the optical scanner 100. In some embodiments, the linear polarizer 112 of the optical scanner 100 may be configured to receive the highly polarized light 118 from the collimator lens 110 (e.g., the beam of parallel light 120). In some embodiments, the linear polarizer 112 may be configured to convert the highly polarized light 118 into the linear polarized light 124 (illustrated in FIG. 3A).

In some embodiments, the quarter-wave plate 114 of the optical scanner 100 may be configured to receive the linear polarized light 124 and convert the linear polarized light 124 into the circularly polarized light 126 (illustrated in FIG. 3B). In some embodiments, the circularly polarized light 126 converted from the linear polarized light 124 by the quarter-wave plate 114, may correspond to the left-handed circularly polarized light or the right-handed circularly polarized light. In some embodiments, the quarter-wave plate 114 of the optical scanner 100 may comprise a first axis 204 (i.e., fast axis) and a second axis 206 (i.e., a slow axis). In some embodiments, the first axis 204 of the quarter-wave plate 114 may be positioned perpendicular to the second axis 206 of the quarter-wave plate 114. In some embodiments, the quarter-wave plate 114 of the optical scanner 100 may be positioned relative to the linear polarizer 112 such that the first axis 204 and the second axis 206 of the quarter-wave plate 114 each forms a 45-degrees angle with the axis of the linear polarizer 112 (i.e., the vertical polarization axis 122).

In some embodiments, the quarter-wave plate 114 may be configured to convert the linear polarized light 124 into the circularly polarized light 126. In some embodiments, the circularly polarized light 126 may correspond to the left-handed circularly polarized light or the right-handed circularly polarized light. In various examples, when the first axis 204 of the quarter-wave plate arranged in clockwise direction from the axis of the linear polarizer 112 (i.e., the vertical polarization axis 122) and the second axis 206 of the quarter-wave plate arranged in anti-clockwise direction from the axis of the linear polarizer 112, then the circularly polarized light 126 corresponds to right-handed circularly polarized light. In various examples, when the first axis 204 of the quarter-wave plate arranged in anti-clockwise direction from the axis of the linear polarizer 112 (i.e., the vertical polarization axis 122) and the second axis 206 of the quarter-wave plate arranged in clockwise direction from the axis of the linear polarizer 112, then the circularly polarized light 126 corresponds to left-handed circularly polarized light.

In some embodiments, the window 116 of the optical scanner 100 may be configured to receive the circularly polarized light 126 (e.g., the left-handed circularly polarized light or the right-handed circularly polarized light). In some embodiments, the window 116 of the optical scanner 100 may be configured to allow passage to the circularly polarized light 126. In some embodiments, the circularly polarized light 126 passed through the window 116, may be configured to strike over the target plane 128 of at least one object. In some embodiments, the optical scanner 100 may be configured to scan the one or more visual codes imprinted on the target plane 128 of the at least on object through the circularly polarized light 126 passed through the window 116.

In some embodiments, the window 116 of the optical scanner 100 may be configured to reflect a portion of the circularly polarized light 130 back towards the quarter-wave plate 114, as depicted by an arrow 208 in FIG. 2B. In various examples, the window 116 may be configured to reflect the left-handed circularly polarized light into the right-handed circularly polarized light or to reflect the right-handed circularly polarized light into the left-handed circularly polarized light. In some embodiments, the quarter-wave plate 114 of the optical scanner 100 may be configured to receive the portion of the circularly polarized light 130 that may be reflected by the window 116. In some embodiments, the quarter-wave plate 114 may be configured to convert the left-handed circularly polarized light or the right-handed circularly polarized light received from the window 116 into the vertically polarized light 132. In some embodiments, the vertically polarized light 132 may define a direction. In some embodiments, the direction of the vertically polarized light 132 may be perpendicular to the axis of the linear polarizer 112 (i.e., the vertical polarization axis 122). In some embodiments, the linear polarizer 112 of the optical scanner 100 may be configured to block the vertically polarized light 132. In some embodiments, the linear polarizer 112 and the quarter-wave plate 114 may be configured to prevent back reflection of the circularly polarized light 126 from the window 116 from reaching the aimer light source 108 for preventing an aimer ghost light.

In some embodiments, a method for the optical scanner 100 is disclosed. The method may comprise one or more operations. At an operation, the aimer light source 108 of the optical scanner 100 may be configured to emit the highly polarized light 118. The aimer light source 108 may correspond to at least the visible laser diode (VLD) light source. The aimer light source 108 may be integrated within the aimer 102 of the optical scanner 100. At another operation, the linear polarizer 112 positioned between the aimer light source 108 and the window 116 may be configured to convert the highly polarized light 118 received from the aimer light source 108 into linear polarized light 124. At another operation, the quarter-wave plate 114 positioned between the linear polarizer 112 and the window 116 may be configured to convert the linear polarized light 124 received from the linear polarizer 112 into circularly polarized light 126. The circularly polarized light 126 converted from the linear polarized light 124 by the quarter-wave plate 114 may correspond to left-handed circularly polarized light or right-handed circularly polarized light. The linear polarizer 112 and the quarter-wave plate 114 may be configured to prevent back reflection of the circularly polarized light 126 from the window 116 from reaching the aimer light source 108, for preventing the aimer ghost light.

The present disclosure streamlines prevention of the aimer ghost light in the optical scanner 100. Embodiments of the present disclosure convert the linear polarized light 124 into the vertically polarized light through the linear polarizer 112, quarter-wave plate, and the window 116. The present disclosure ensures a precise scanning of one or more visual codes on at least one object.

Many modifications and other embodiments of the disclosure set forth herein will come to mind to one skilled in the art to which the present disclosure pertains to having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An optical scanner comprising:
an aimer light source to emit highly polarized light;
a window;
a linear polarizer positioned between the aimer light source and the window, wherein the linear polarizer receives the highly polarized light and converts into linear polarized light; and,
a quarter-wave plate positioned between the linear polarizer and the window, wherein the quarter-wave plate receives the linear polarized light and converts into circularly polarized light; wherein the linear polarizer and the quarter-wave plate prevent back reflection of the circularly polarized light from the window from reaching the aimer light source for preventing an aimer ghost light.

2. The optical scanner of claim 1, wherein the aimer light source corresponds to at least a visible laser diode (VLD) light source.

3. The optical scanner of claim 1, further comprising a collimator lens positioned between the aimer light source and the linear polarizer.

4. The optical scanner of claim 3, wherein the collimator lens collimates the highly polarized light into a beam of parallel light that is received by the linear polarizer.

5. The optical scanner of claim 1, wherein the highly polarized light is converted into the linear polarized light with parallel direction by the linear polarizer.

6. The optical scanner of claim 1, wherein the circularly polarized light converted from the linear polarized light by the quarter-wave plate corresponds to left-handed circularly polarized light or right-handed circularly polarized light.

7. The optical scanner of claim 6, wherein the window reflects the left-handed circularly polarized light into the right-handed circularly polarized light or the right-handed circularly polarized light into the left-handed circularly polarized light.

8. The optical scanner of claim 7, wherein the quarter-wave plate converts the left-handed circularly polarized light or the right-handed circularly polarized light received from the window into vertically polarized light.

9. The optical scanner of claim 8, wherein a direction of the vertically polarized light is perpendicular to an axis of the linear polarizer such that the linear polarizer prevents the vertically polarized light from reflecting back to the aimer light source and thereby preventing the aimer ghost light.

10. The optical scanner of claim 9, wherein the axis of the linear polarizer is positioned in a predefined degree to transmit the linear polarized light at a maximum intensity.

11. The optical scanner of claim 9, wherein the quarter-wave plate comprises a first axis and a second axis; and,
wherein the quarter-wave plate is positioned relative to the linear polarizer such that the first axis and the second axis of the quarter-wave plate each form a 45-degrees angle with the axis of the linear polarizer.

12. The optical scanner of claim 3, wherein the aimer light source, the collimator lens, the linear polarizer, the quarter-wave plate, and the window are positioned in a same plane and collectively generate an aimer light.

13. A method comprising:
emitting, via an aimer light source of an optical scanner, highly polarized light;
converting, via a linear polarizer positioned between the aimer light source and a window, the highly polarized light received from the aimer light source into linear polarized light; and,
converting, via a quarter-wave plate positioned between the linear polarizer and the window, the linear polarized light received from the linear polarizer into circularly polarized light; wherein the linear polarizer and the quarter-wave plate prevent back reflection of the circularly polarized light from the window from reaching the aimer light source, for preventing an aimer ghost light.

14. The method of claim 13, wherein the aimer light source corresponds to at least a visible laser diode (VLD) light source.

15. The method of claim 13, further comprising positioning a collimator lens between the aimer light source and the linear polarizer, wherein the collimator lens collimates the highly polarized light into a beam of parallel light that is received by the linear polarizer.

16. The method of claim 13, wherein the highly polarized light is converted into the linear polarized light with parallel direction, by the linear polarizer.

17. The method of claim 13, wherein the circularly polarized light converted from the linear polarized light by the quarter-wave plate corresponds to left-handed circularly polarized light or right-handed circularly polarized light.

18. The method of claim 17, further comprising reflecting, via the window, the left-handed circularly polarized light into the right-handed circularly polarized light or the right-handed circularly polarized light into the left-handed circularly polarized light.

19. The method of claim 17, further comprising converting, via the quarter-wave plate, the left-handed circularly polarized light or the right-handed circularly polarized light received from the window into vertically polarized light, wherein a direction of the vertically polarized light is perpendicular to an axis of the linear polarizer, such that the linear polarizer prevents, the vertically polarized light from reflecting back to the aimer light source and thereby preventing the aimer ghost light, wherein the axis of the linear polarizer is positioned in a predefined degree to transmit the linear polarized light at a maximum intensity.

20. The method of claim 19, wherein the quarter-wave plate comprises a first axis and a second axis, and, wherein the quarter-wave plate is positioned relative to the linear polarizer such that the first axis and the second axis of the quarter-wave plate each form a 45-degrees angle with the axis of the linear polarizer.
